(19) United States
(12) Patent Application Publication
(10) Pub. No.: US 2005/0196504 A1
(43) Pub. Date: Sep. 8, 2005

(54) Reduction of acrylamide in processed foods

(76) Inventor: John Westcott Finley, Lansdale, PA (US)

Correspondence Address: KRAFT / FETF, 120 S. LASALLE STREET, SUITE 1600, CHICAGO, IL, 60603-3406, US

(21) Appl. No.: 10/793,343

(22) Filed: Mar. 4, 2004

(51) Int. Cl. G01L 1/20

(52) U.S. Cl. 426/549

(57) ABSTRACT

Methods are provided for reducing the amounts of acrylamide and/or buteneamide in processed foods. The invention further relates to methods for treating processed foods with inhibitors, including organic amino compound, organic sulfhydryl compounds, and certain other compounds (e.g., disulfide reducing agents), to reduce the amount of acrylamide and/or buteneamide in processed food exposed to high temperature conditions (generally above about 110° C.) during manufacturing or cooking.

### FIELD OF THE INVENTION

This invention relates to methods for reducing the amounts of acrylamide and/or buteneamide in processed foods. The invention further relates to methods for treating processed foods with inhibitors, including organic amino compound, organic sulfhydryl compounds, and certain other compounds (e.g., disulfide reducing agents), to reduce the amount acrylamide and/or buteneamide in processed food exposed to high temperature conditions (generally above about 110° C.) during manufacturing or cooking.

### BACKGROUND OF THE INVENTION

In April 2002, researchers at the Swedish National Food Administration and Stockholm University reported finding the chemical acrylamide in a variety of fried and oven-baked foods. The initial research indicated that acrylamide formation is particularly associated with high temperature cooking processes, such as frying or baking, for certain carbohydrate-rich or starchy foods. Since the Swedish report came out, these finding have been corroborated by other research groups.

Acrylamide appears to formed as a by product of high-temperature cooking processes (greater than about 120° C. or 248° F.), particularly in carbohydrate-rich foods such as potatoes and cereals. It does not appear to be present in uncooked food; it appears to be present in low or undetectable levels in foods cooked at lower temperatures (e.g., boiling and similar low temperature cooking processes).

The discovery of the presence of acrylamide in a variety of cooked foods, particularly baked and fried foods, has stimulated worldwide interest. (Tareke et al., Analysis of Acrylamide in Heated Foodstuffs, J. Agric. Food Chem. 50(17): 4998-5006 (2002); Rosen et al, Analysis of Acrylamide in Cooked Foods by Liquid Chromatography Tandem Mass Spectrometry, Analyst 127: 880-882 (2002)).

It is likely that acrylamides have been consumed since man started to cook food. Recent reports have identified the major pathway for acrylamide formation. (Stadler et al., Acrylamide from Maillard Reaction Products, Nature 419: 449-50 (2002); Mottram, et al., Acrylamide is formed in the Maillard reaction, Nature 419: 448-9 (2002); Sanders et al., An LC/MS Acrylamide Method and its Use in Investigating the Role of Asparagine, Presentation: 116^{th} International AOAC Meeting, (Sep. 26, 2002) Los Angeles, Calif. USA.)).

The route of formation is thought to occur via the Maillard reaction of free asparagine with a carbonyl compound eventually forming acrylamide from the amide end of the asparagine. Acrylamide levels in processed foods range from zero to over 3000 ppb. (Tareke et al., Analysis of Acrylamide in Heated Foodstuffs, J. Agric. Food Chem. 50(17): 4998-5006 (2002); Rosen et al, Analysis of acrylamide in cooked foods by liquid chromatography tandom mass spectrometry, Analyst 127: 880-882 (2002); Sanders et al., An LC/MS Acrylamide Method and its Use in Investigating the Role of Asparagine, Presentation: 116^{th} International AOAC Meeting, (Sep. 26, 2002) Los Angeles, Calif. U.S.A.; www.food.gov.uk/multimedia/pdfs/acrylamideback.pdf; Palevitz, Plastic in My French Fries, The Scientist 161(17): 26-8 (2002)). A number of factors are likely to influence the levels of acrylamide found in food products, including the levels of asparagine and carbonyl compounds in the starting material, the time and temperature of processing, and the potential for side reactions in the product. Acrylamide is a reactive material capable of forming Michael addition products with amino groups and sulfhydryl groups on amino acids or proteins. Tareke et al. (Analysis of Acrylamide in Heated Foodstuffs, J. Agric. Food Chem. 50(17): 4998-5006 (2002)) have reported the formation of the Michael addition product between acrylamide and the N-terminal group of hemoglobin resulting in N-(2-carbamoyl)valine. Earlier, Friedman reported that a number of vinyl compounds including acrylamide can react with sulfhydryl groups of cysteine. (Friedman et al., Relative Nucleophilic Reactivities of Amino Groups and Mercaptide ions with α,β-Unsaturated compounds. J. Am. Chem. Soc. 87(16): 3672-3682 (1965)).

One potential mechanism which leads to the formation of acrylamide in carbohydrate-rich foods cooked at high temperatures is the Maillard reaction, a chemical reaction between the amino acid asparagine and certain sugars, both of which are found naturally in foods. A similar reaction can occur with glutamine, leading to the production of buteneamide. Since most plant foods contain the free amino acids asparagine and glutamine, the potential for the formation of acrylamide or buteneamide is significant. Potatoes contain significant quantities of free asparagines, and, as a result, fried potato products such as chips and fries have been shown to produce acrylamide during the frying process.

The present invention provides methods to prevent or reduce formation of acrylamide and/or buteneamide in food products.

### SUMMARY OF THE INVENTION

In accordance with the present invention, a method is provided for reducing the amount of acrylamide and/or buteneamide in a processed food product comprising treating the food product with an inhibitor or scavenger, including organic amino- or sulfhydryl-containing compounds, prior to cooking the food product. In one embodiment, the present invention provides a method for reducing the amount of acrylamide and/or buteneamide in a processed food product which is subjected to high heat conditions (generally above about 110° C.) during processing, said method comprising treating the food product with an effective amount of an inhibitor prior to subjecting the food product to the high heat conditions, whereby the amount of acrylamide or buteneamide present in the processed food product is reduced by at least about 30 percent relative to a similar processed food product prepared in a similar manner but without the inhibitor. In another embodiment, the present invention provides a method for reducing the amount of acrylamide and/or buteneamide in a processed food product which is subjected to high heat conditions (generally above about 110° C.) during processing, said comprising treating the food product with an effective amount of an inhibitor to reduce the amount of asparagine or glutamine in the food product prior to subjecting the food to the high heat conditions, whereby the amount of acrylamide or buteneamide present in the processed food product is reduced by at least about 50 percent relative to a similar processed food product prepared in a similar manner but without the inhibitor. Preferably, the amount of acrylamide or buteneamide present in the processed food product is reduced by at least about 80 percent relative to a similar processed food product prepared in a similar manner but without the inhibitor. For purpose of this invention, “inhibitor” is intended to include compounds, as described herein, which either (1) inhibit or prevent the initial formation of acrylamide and/or buteneamide or (2) react with, or scavenge, acrylamide and/or buteneamide that may be formed or otherwise present in the food product so as to reduce the amounts of acrylamide and/or buteneamide relative to the amounts found in similar food products without the inhibitor treatment.

### DETAILED DESCRIPTION OF THE PREFERRED EMBODIMENTS

Chemical compounds have been discovered that inhibit the formation of, and/or reduce the amounts, of acrylamide and/or related materials (e.g., buteneamide) in foods and processed ingredients. Although not wishing to be limited by theory, the Maillard browning reaction appears to be a key step in the initiation of acrylamide formation in foods. A primary precursor of acrylamide formation is the amino acid asparagine. Potatoes and many other foods are rich in asparagine and glutamine as free amino acids. The formation of acrylamide from asparagine and the formation of buteneamide from glutamine are thought to proceed by the initial formation of a glucose addition product on the alpha amino group of the amino acid. This unstable browning intermediate decomposes by a Strecker degradation. The result is a decarboxylation and abstraction of the amino group by the glucose moiety leaving an unsaturated product from the amino acid. In the case of asparagines, the resultant product is acrylamide; for glutamine, the product would be buteneamide.

Addition of inhibitors of the browning and/or similar acrylamide- or buteneamide-forming reactions during food processing, but before exposure to high temperature conditions, can inhibit the formation of acrylamide and buteneamide. In accordance with the present invention, compounds containing active thiol groups and certain other compounds are very effective 25 for inhibiting acrylamide formation. Of course, the inhibitors and/or scavengers used in the present invention should be compatible with food products and should not impart unacceptable flavor or other attributes to the food products. For example, as shown below, mercapto acetic acid, N-acetyl-cysteine, glutathione, EDTA, and citric acid are effective to inhibit acrylamide formation. Mercapto acetic acid, mercapthothanol, and mercaptopropionic acid, although effective in reducing acrylamide concentrations, generally introduce significant flavor defects and are, therefore, not preferred; such compounds can be used, however, so long as the flavor defects are masked or are otherwise acceptable. Generally, compounds containing active thiol groups are generally preferred. Other suitable compounds containing active thiol groups include, for example, proteins with free sulfhydryl groups, peptides with free sulfhydryl groups, and the like. Lysine, N-α-acylated-lysine, and peptides rich in lysine, arginine, ornithine or histidine will also scavenge acrylamide and buteneamide. The most preferred inhibitors for use in the present invention include N-acetyl-cysteine, cysteine rich peptide, and mixtures thereof. Mixtures of such compounds as mentioned herein can also be used.

The methods according to the present invention can be applied widely to food products, particularly fried and baked products such as potato products, cookies, crackers, and flat breads. Active thiols are particularly useful inhibitors of acrylamide formation because they are effective at low concentrations, non-toxic, and cost effective. Reaction flavors where protein hydrolyzates are used as starting materials may also form acrylamide. Thus, addition of low levels of the thiols would also protect these products from forming acrylamide or buteneamide.

In accordance with the present invention, the levels of acrylamide resulting from manufacturing or cooking at high temperatures (generally above about 110° C.) are reduced by taking advantage of the high reactivity of acrylamide with sulfhydryl groups and/or amino groups. While the present invention is not limited by any theory regarding the mechanism of action, it is thought that the addition of sulfhydryl groups acts to slow the initial Maillard reaction and/or that the sulfhydryl groups act as scavengers to remove any acrylamide that is formed. The methods of the present invention can be used to significantly reduce the amount of acrylamide found in processed or cooked foods.

Examples of preferred sulfhydryl containing compounds according to the present invention include N-acetyl-cysteine, glutathione, proteins or peptides having free sulfhydryl groups, proteins or peptides rich in lysine or ornithine, and the like as well as mixtures thereof. In a preferred embodiment, the inhibitors are cysteine or N-acetyl-cysteine.

The present invention involves exposure of the food product, prior to high temperature (generally greater than about 110° C., preferably greater than about 150° C.) cooking to an effective amount of an inhibitor for an effective time to significantly reduce acrylamide and/or buteneamide formation normally observed during high temperature cooking processes. Generally, an effective amount of inhibitor and an effective exposure time is such that the amount of acrylamide and/or buteneamide formed is reduced by at least about 30 percent (preferably at least about 50 percent and more preferably at least about 80 percent) relative to a similarly prepared process food without the inhibitor treatment. Generally, the food product, preferably cut or formed in the desired shape, is treated with an aqueous solution containing about 0.005 to about 2 percent of the inhibitor for about 1 to about 60 minutes. More preferably, the food product is treated with an aqueous solution containing about 0.05 to about 0.2 percent of the inhibitor for about 1 to about 30 minutes. Generally, the ratio of food product to treatment solution is about 1 to about 10, and more preferably about 1 to about 3. After the inhibitor treatment, the inhibitor solution is removed (e.g., draining, blotting, spinning, air curtain, or similar methods) and the food product then processed in the normal manner (i.e., cooking, packaged or stored for later cooking, and the like). Preferably, the inhibitor-treated food product is washed one or more times to more completely remove inhibitor compounds from the food product prior to further processing. Thus, using french fried potatoes as an example, the desired potatoes are washed, cut into the desired form, and treated with the selected inhibitor solution for the desired time period. After treatment, excess inhibitor solution is preferably removed using any suitable method (e.g., draining, blotting, spinning, air curtain, and the like). If desired the treated french fried potatoes may be washed one or more times with an aqueous solution to further remove inhibitor. The inhibitor treated french fries may then be processed in the normal manner. For example, the inhibitor treated french fries may be cooked immediately in a conventional frier or may be packaged, frozen, and stored using conventional techniques for later cooking in a conventional frier.

In some cases (e.g., macerated or mashed food products like mashed potatoes), the inhibitor solution may simply be added directly to the food product prior to any heat treatment. In such cases, the level of inhibitors are generally at about 0.001 to about 1 percent of the total formulation. Thus, for example, a mashed potato formulation may be prepared containing an effective amount of an inhibitor, formed into the desired shape, and then fried at elevated temperatures to provide a potato product containing reduced levels of acrylamide and/or buteneamide.

As suggested above, the sulfhydryl groups can also be generated in situ by treatment with disulfide reducing agents. In such case, the disulfide groups in proteins or peptide within the food product are reduced to sulfhydryl groups which can then act as inhibitor or scavengers for acrylamide and buteneamide. Thus reducing agents capable of reduction of disulfide bonds to sulfhydryl groups will help reduce acrylamide levels in products. For example, ascorbic acid, EDTA, citric acid, malic acid, glutaric acid, dicarboxylic acids, and dicarboxylic amino acids (e.g., glutamic acid or aspartic acid) are effective in reducing disulfides to sulfhydryl groups. Thus, the addition of reducing agents such as ascorbic acid, citric acid, malic acid, glutaric acid, dicarboxylic acids, dicarboxylic amino acids, or mixtures thereof can be used to reduce acrylamide in baked products or grain products receiving intense heat treatment such as breakfast cereals. Although not wishing to be limited by theory, it is thought that the resulting sulfhydryl groups will react with acrylamide through the Michael addition reaction. Other antioxidants (e.g., tributyl phosphine) capable of reducing disulfides could be used in a similar manner.

Many of these same techniques can also be used to remove acrylamide from liquid food products (e.g., coffee, soup, bouillon, liquid flavors, reaction flavors, and the like). For example, such acrylamide-containing liquid food products could be passed over or through a matrix containing free sulfhydryl groups or free alkyl amino groups (e.g., c-amino groups, lysine in a lysine rich protein, synthetic peptides such as polylysine or polyornithine, and the like). Alternatively, alkyl sulfhydryl groups can be affixed to synthetic filtration backbones such as derivatized silica or other polymers. Alternatively, a matrix of hair or wool treated with a disulfide reducing agent (e.g., tributyl phosphine or mercaptoacetic acid) could also be used to remove acrylamide from a liquid food product; preferably such a matrix would be washed to remove the lipids and lanolin prior to the disulfide reduction treatment. Alternatively, a coffee filter containing such a treated matrix or polymer could be used to remove acrylamide from a liquid food product. Such method could also be used to remove acrylamide from soluble coffee prior to drying.

The following examples are intended to illustrate the invention and not to limit it. Numerous modifications may be made by those skilled in the art without departing from the true spirit and scope of the invention. Unless noted otherwise, all percentages and ratios are by weight.

### EXAMPLES

The following general experimental procedures were used.

Quantification of Acrylamide. The analysis of acrylamide in french fries was performed with a modified version of the FDA HPLC-MS/MS method for “Detection and Quantization of Acrylamide in Food” (see, www.cfsan.fda.gov/˜dms/acrylami.html). The modifications to the FDA procedure involve replacing formic acid with acetic acid and eluting acrylamide from the Oasis HLB SPE cartridges with two 1 mL portions of 2% methanol: 98% water: 0.1% acetic acid. The second 1 mL fraction is collected for analysis.

Room temperature extractions involved weighing a one gram portion of the homogenized french fry sample into a 15 mL polypropylene graduated conical tube and adding 9.8 mL of 0.1% acetic acid plus 0.2 mL of 1 mg/L internal standard. The tubes were then shaken on an Orbit Shaker for 60 minutes. The samples were then centrifuged for 5 minutes at 3400 rpm and 20° C. A 2 mL aliquot was taken from the supernatant for solid phase extraction (SPE).

HPLC-Mass Spectrometry Conditions. A Waters Alliance 2695 HPLC (Waters Corporation, Milford, Mass., U.S.A.) was coupled directly to a Finnigan MAT TSQ 700 (triple-stage quadrupole) mass spectrometer (ThermoFinnigan, San Jose, Calif., U.S.A.) equipped with a Finnigan electrospray ionization (ESI) source (API 1). The HPLC column used was a Phenomenex Aqua (3 micron particle size), 2.0×150 mm with an appropriate guard column, column temperature of 30° C., and flow rate of 0.200 mL/min. The HPLC separation was isocratic with 0.5% methanol and 0.1% acetic acid in water. Selected-reaction monitoring was used for the analyses with a retention-time dependent computer program written in TSQ700's instrument control language (ICL). The mass spectrometer was programmed to transmit the precursor ions through the first quadrupole (Q₁), where the ions underwent collision-induced fragmentation, to Q₃, where the product ions were monitored. A collision gas pressure of 2.1 mTorr (Argon) was employed and the collision offset was −14 V. The precursor ions were m/z 72 for acrylamide and m/z 75 for the internal standard (Acrylamide-1,2,3-¹³C₃), and the product ions were m/z 55 for acrylamide and m/z 58 for the internal standard.

### Example 1

Russet potatoes were obtained from a local supermarket, peeled, and sliced into ¼ inch strips for frying. The potato strips were soaked for one hour in water solutions containing a variety of reagents, as indicated in Table 1, to inhibit the Maillard reaction. In all cases, 75 g of potato strips were soaked in 500 ml of the aqueous solution. The potatoes were then drained and fried for 3 minutes at 170° C. in soy oil, frozen, and submitted for analysis.

The results of Example 1 are summarized in Table 1 below:

TABLE 1

| | Molecular | | |
|---|---|---|---|
| Inhibitor | Weight | Concentration (mM) | Acrylamide (ppb) |
| None (control) | — | — | 1411.5 |
| Mercapto acetic acid | 92.12 | 27 | >25 |
| N-Acetyl-cysteine | 163.2 | 15 | 126 |
| Glutathione | 307.33 | 8 | 400.5 |
| EDTA | 336.21 | 74 | 699.5 |
| Citric acid | 192.12 | 13 | 284.5 |

### Example 2

French fries were prepared using the procedure outlined in Example 1 using various thiol-containing compounds. The results for acrylamide determination in french fries by room temperature extraction are shown in Table 2 below. Eleven french fry samples were analyzed in this experiment. The initial control was carried out first, followed by the samples treated with thiol-containing compounds, followed by the final control. The samples were homogenized and keep frozen at −20° C. prior to analysis. Spiked recovery analyses of acrylamide were previously shown to be in the high 90 percent range for french fries. All sample recoveries fell within the range of the standards covering 2 to 100 ppb with an R² correlation of 0.9997. No interferences were detected in samples or process blanks for the internal standard and the target analyte acrylamide. Replicate values were generated by the analysis of two separate sample preparations.

TABLE 2

| | Acrylamide in French Fries (ppb) | |
|---|---|---|
| Treatment | Replicate 1 | Replicate 2 |
| Initial Control | 739 | 775 |
| Final Control | 469 | 496 |
| 0.125% N-Acetyl-cysteine | 381 | 373 |
| 0.250% N-Acetyl-cysteine | 453 | 408 |
| 0.50% N-Acetyl-cysteine | 228 | 225 |
| 0.25% Glutathione | 278 | 233 |
| 0.25% Sodium Thiosulphate | 658 | 621 |
| 0.25% Sodium sulfite | 619 | 617 |
| 0.25% Thiolacetic acid | 44 | 47 |
| 0.25% Thiolpropionic Acid | 111 | 92 |
| 0.25% N-Acetyl-cysteine | 206 | 225 |

As demonstrated in this example, organic thiol compounds were effective in reducing acrylamide levels; inorganic thiol compounds were not effective.

### Example 3

In this example, twenty-one french fry samples were prepared and analyzed as in Examples 1 and 2. The samples were homogenized and keep frozen at −20° C. prior to analysis. Replicate values were generated by the analysis of two separate sample preparations. The results for acrylamide determination in french fries by room temperature extraction are shown in Table 3 below.

TABLE 3

| | Acrylamide in French | |
|---|---|---|
| | Fries (ppb) | |
| Sample | Replicate 1 | Replicate 2 |
| Control Unblanched Before | 2128 | 1861 |
| Control Unblanched Post | 1065 | 1041 |
| Control Blanched Before | 638 | 649 |
| Control Blanched Post | 264 | 235 |
| Garlic Juice Unblanched | 730 | 672 |
| Onion Juice Unblanched | 744 | 675 |
| 1% Whey Unblanched | 1183 | 1116 |
| 0.5% Glutathione Unblanched | 269 | 249 |
| 0.5% Glutathione Blanched | <5 | <5 |
| 0.125% Cysteine Unblanched | 775 | 737 |
| 0.25% Cysteine Unblanched | 407 | 418 |
| 0.5% Cysteine Unblanched | 301 | 282 |
| 0.125% Cysteine Blanched | <5 | <5 |
| 0.25% Cysteine Blanched | <5 | <5 |
| 0.5% Cysteine Blanched | <5 | <5 |
| 0.125% N-Acetyl-cysteine Unblanched | 509 | 499 |
| 0.25% N-Acetyl-cysteine Unblanched | 263 | 294 |
| 0.5% N-Acetyl-cysteine Unblanched | 132 | 112 |
| 0.125% N-Acetyl-cysteine Blanched | 23 | 14 |
| 0.25% N-Acetyl-cysteine Blanched | 19 | 19 |
| 0.5% N-Acetyl-cysteine Blanched | 7 | 5 |

The variability in controls is related to variability in potatoes and the fact that post treatments had longer exposure to water which removed more of the starting materials. The lower the starting materials in asparagine and glucose, the lower the tendency to form acrylamide.

### Example 4

Russet potatoes were purchased from a local market. The potatoes were peeled and cut into 0.95 cm square strips. The raw potato strips were then submersed in water or solutions containing the various sulfhydryl materials being tested (Example 4A). Alternatively, the potato strips were blanched in boiling water for 1 minute (about 75 g potato strips in 750 ml water), drained and blotted, and then soaked in water or solutions containing the various sulfhydryl materials being tested (Example 4B). All potato samples were soaked for one hour before frying. In each case, 75 g of potato strips were submersed in 400 ml of solution for the soaking step. The potato strips were fried for 4 minutes at 170° C., removed from the soy oil, drained, and frozen prior to analysis.

The results from Example 4A are shown in Table 4A below. From the data it can be seen that each of the sulfhydryl compounds used was effective in reducing the acrylamide level in the fried potatoes in this system. The citric acid is known to inhibit the browning reaction, and it did provide a substantial reduction in acrylamide formation (i.e., control contained about 1400 ppb acrylamide and treated sample about 275 ppb acrylamide). The sulfhydryl containing compounds all provided a significant reduction in acrylamide. The reduction of acrylamide production is approximately linear with the sulfhydryl concentration in the solution. Similar treatment with sodium sulfite was not effective (e.g., control at about 1400 ppb and treated sample at about 1360 ppb acrylamide).

TABLE 4A

| | Acrylamide in |
|---|---|
| Sample | product (ppb) |
| Fresh Potato Control | 1524 |
| Soaked in 0.125% Cysteine | 756 |
| Soaked in 0.25% Cysteine | 413 |
| Soaked in 0.50% Cysteine | 292 |
| Soaked in 0.125% N-α-Acetyl-cysteine | 504 |
| Soaked in 0.25% N-α-Acetyl-cysteine | 279 |
| Soaked in 0.50% N-α-Acetyl-cysteine | 122 |

In Example 4B, with a different batch of potatoes the concentrations of the sulfhydryl compounds were varied, and a blanching step was introduced into the process. In Table 4B, it can be seen that blanching significantly reduced the observed levels of acrylamide formation and that the sulfhydryl groups significantly enhanced the reduction of acrylamide in both blanched and unblanched potatoes.

TABLE 4B

| | Acrylamide in product |
|---|---|
| Sample | (ppb) |
| Blanched Potato Control | 446 |
| Soaked in 0.125% Cysteine | <5 |
| Soaked in 0.25% Cysteine | <5 |
| Soaked in 0.50% Cysteine | <5 |
| Soaked in 0.125% N-α-Acetyl-cysteine | 19 |
| Soaked in 0.25% N-α-Acetyl-cysteine | 19 |
| Soaked in 0.50% N-α-Acetyl-cysteine | 6 |

Blanching had a dramatic effect on reducing the acrylamide. This is due in part to the fact that after blanching, the water was discarded and the potatoes were placed in fresh solutions. The asparagine in the starting material is highly soluble and may have been washed away.

In the same study, fries were soaked in 0.5% reduced glutathione solution using the same procedure as detailed above. The recovered acrylamide concentrations in unblanched and blanched potatoes were 259 ppb and <5 ppb, respectively.

From the data it is clear that sulfhydryl containing compounds significantly reduce the acrylamide found in fried potato products.

To further test this observation, the acrylamide formation in fried potato strips from the study in Table 4A were analyzed after soaking for one hour in solutions containing 1% juice squeezed form either garlic or onions. The results were 746 ppb acrylamide in the sample exposed to the garlic juice and 710 ppb acrylamide in the sample exposed to the onion juice.

These results suggest that acrylamide levels in foods can be reduced through the direct addition of sulfhydryl containing compounds in the food processing. Mercaptoacetic acid and mercaptopropionic acid were also found to effectively reduce acrylamide levels in fried products. The effect of the sulfhydryl compounds appears to correlate well with the levels of sulfhydryl groups present in the soaking solution.

### Example 5

The reaction between the sulfhydryl groups and acrylamide was confirmed by reacting 0.25 mmoles of N-α-acetyl-cysteine with 2× molar excess acrylamide at 100® C. for 10 minutes. The resulting adduct (i.e., N-α-acetyl-S-acetamido-cysteine) was confirmed by proton and carbon NMR.

From the foregoing examples, it has been shown that the sulfhydryl compounds useful according to the present invention can come from food sources, such as garlic or onions, or may be provided through direct addition of amino acids or peptides containing cysteine as an effective means for reducing the acrylamide concentration in processed foods. It is likely that the reducing agents retard the Maillard reaction. Further, any acrylamide formed may react directly with the sulfhydryl groups to form a Michael addition product, thus scavenging acrylamide from the system.

1. A method for reducing acrylamide in a food product comprising treating the food product, prior to cooking the food product, with an inhibitor selected from the group consisting of a sulfhydryl-containing compound, an amino-containing compound, a disulfide reducing agent, and mixtures thereof.

2. The method according to claim 1, wherein the inhibitor is the sulfhydryl-containing compound.

3. The method according to claim 1, wherein the inhibitor is the amino-containing compound.

4. The method according to claim 1, wherein the inhibitor is selected from the group consisting of cysteine, acetyl-cysteine, and glutathione.

5. The method according to claim 1, wherein the inhibitor is selected from the group consisting of ascorbic acid, ethylenediaminetetraacetic acid, citric acid, malic acid, glutaric acid, dicarboxylic acids, dicarboxylic amino acids, and mixtures thereof.

6. The method according to claim 1, wherein the food product is a potato containing product, a cracker, a cookie, or a breakfast cereal.

7. A method for reducing acrylamide in a processed food product comprising:
(1) blanching a food product in water;
(2) treating the blanched food product with an inhibitor selected from the group consisting of sulfhydryl containing compounds, amino-containing compounds, disulfide reducing agents, and mixtures thereof; and
(3) cooking the food product.

8. The method of claim 7, wherein the food product contains potato.

9. The method of claim 7, wherein the cooking comprises frying or baking.

10. The method according to claim 7, wherein the inhibitor is the sulfhydryl-containing compound.

11. The method according to claim 7, wherein the inhibitor is the amino-containing compound.

12. The method according to claim 7, wherein the inhibitor is selected from the group consisting of cysteine, acetyl-cysteine, and glutathione.

13. The method according to claim 7, wherein the inhibitor is selected from the group consisting of ascorbic acid, ethylenediaminetetraacetic acid, citric acid, malic acid, glutaric acid, dicarboxylic acids, dicarboxylic amino acids, and mixtures thereof.

14. A method for reducing acrylamide in a liquid food product comprising passing the liquid product, prior to cooking the food product, through or over a matrix containing an inhibitor selected from the group consisting of a sulfhydryl-containing compound, an amino-containing compound, a disulfide reducing agent, and mixtures thereof.

15. The method according to claim 14, wherein the liquid food product is coffee.

16. The method according to claim 15, wherein the matrix is in the form of a coffee filter.

17. The method according to claim 14, wherein the matrix is washed wool which has been treated with mercaptoacetic acid or tributylyphosphine to reduce disulfides groups in the wool to sulfhydryl groups.
